(19) United States
(12) Patent Application Publication
(10) Pub. No.: US 2026/0134296 A1
(43) Pub. Date: May 14, 2026

(54) EVOLUTIONARY ALGORITHM FOR AUTOMATED RULE GENERATION

(71) Applicant: MASTERCARD TECHNOLOGIES CANADA ULC, Vancouver (CA)

(72) Inventors: Brian MUKESWE, Burnaby (CA); Wyatt SHARBER, Seattle, WA (US)

(73) Assignee: MASTERCARD TECHNOLOGIES CANADA ULC, Vancouver (CA)

(21) Appl. No.: 18/944,519

(22) Filed: Nov. 12, 2024

(51) Int. Cl. G06N 3/126

(52) U.S. Cl. CPC G06N 3/126

(57) ABSTRACT

The disclosure relates to methods and systems of automatically generating rules based on an evolutionary algorithm. A system may generate an initial population of rule candidates bound by a respective constraint. The system may perform a crossover of the initial population of rule candidates with one another to generate a plurality of crossover child rules and may apply a probabilistic mutation to at least some of the plurality of crossover child rules. The system may evaluate performance of the plurality of crossover child rules based on one or more fitness evaluation metrics that measure performance of a given crossover child rule and select a subset of the plurality of crossover child rules based on the evaluated performance. The system may repeat the process until a specified number of evolutionary generations is reached.

### BACKGROUND

Computer systems may use rules to evaluate input data and generate an outcome based on the evaluation. For example, a rule may encode logic that can classify input data based on data values from the input data. To enhance efficiency, rules may be automatically generated through a computational process. Decision tree modeling is the predominant approach for automatic rule generation. A decision tree is a hierarchical in which model decisions are made at hierarchical split points until a final output is reached. At each split point, input data is evaluated to answer a corresponding question. The answer to this question determines the next split point (question about the input data) down the decision tree. Thus, each split point represents a decision that is made that impacts the next question about the input data to be asked at the next split point.

### BRIEF DESCRIPTION OF THE DRAWINGS

Features of the present disclosure may be illustrated by way of example and not limited in the following figure(s), in which like numerals indicate like elements, in which:

FIG. 1 illustrates an example of a system environment of automatically generating rules based on an evolutionary algorithm;

FIG. 2 illustrates an example of evolutionary processes of a rule generation system for generating rules;

FIG. 3A illustrates an example of initializing a population of rules based on randomization;

FIG. 3B illustrates an example of initializing a population of rules based on randomization and rule seeds;

FIG. 3C illustrates an example of initializing a population of rules based on only rule seeds;

FIG. 4 illustrates an example of a method of automatically generating actionable rules based on the evolutionary processes illustrated in FIG. 2;

FIG. 5 illustrates an example of classifying input data based on the automatically generated rules as illustrated in FIG. 4; and

FIG. 6 illustrates an example of a computer system that may be implemented by devices illustrated in FIG. 1.

### DETAILED DESCRIPTION

The disclosure relates to methods and systems of automatically generating machine executable rules based on an evolutionary process that learns to optimize rules based on a fitness evaluation using labeled training data. The automatically generated rules may be actionable from the evolutionary process without post-processing, unlike conventional machine-generated rules such as decision tree approaches to rule generation that may require post-processing to convert the rules into actionable, executable, rules.

For example, decision trees require normalization and standardization for split points/decisions at a node. Thus, decision trees may not perform well with categorical variables because it can be difficult to select a split point for these variables. Categorical variables describe data as categories and are therefore qualitative rather than quantitative. Examples of categorical variables include ordinal categorical variables such as “high,” “medium,” and “low” and nominal categorical variables such as country names/values. Accordingly, categorical rule features must first be encoded into numerical features. Other learning systems may also require vectorization of rule features. Rules that are automatically generated from these features are not immediately actionable because the rules must be decoded and translated back into an actionable rule, such as by normalizing numerical variables. For example, if a feature is transformed (such as being normalized and/or encoded) when creating a decision tree model, the same transformations must be applied to each input record before evaluating rule performance. Alternatively, the inverse of each transformation must be applied to the rule threshold values before evaluating the rule's performance against raw input data records.

The system may address the foregoing by implementing automated rule generation with rules that can include rule features that can include categorical variables. This may be facilitated, in part, using logical constraints as input to an evolutionary algorithm that randomizes rule features and selects for best fit, or top-performing, rules. The constraints may be based on historical data labelled with known outcomes, ensuring that fitness evaluation is based on training data from actual real-world inputs.

Decision trees may be predefined in their search space because they start at a particular root node and make binary decisions as the tree is traversed. This results in an inability to seed the decision tree with existing rules that can be fine-tuned. The rule generation system may address the foregoing by enabling the injection of a set of seed rules for the initial generation of rules, which are randomly crossed with other rules in the generation, probabilistically mutated, evaluated and selected, resulting in fine-tuned seed rules. A seed rule is an already-generated rule that may be evaluated against input data, but may be further fine-tuned. In other words, some or all of the rule features and/or their corresponding rule feature values may be modified by the evolutionary process. In some instances, seed rules may be dropped in favor of better-performing rules. In some instances, seed rules may be fine-tuned by removing one or more of its rule features, adding one or more rule features, and/or other evolutionary processes may be performed on a seed rule during fine-tuning.

The predefined search space of decision trees may also result in a limited search space to find optimal rules, which can result in overfitting. Overfitting occurs when the search space is not sufficiently broad and learning systems learn only from a limited set of data and fitting local optima. This can lead to generation of overly niche rules that fit only a specific set of data. The rule generation system may address the foregoing by searching a large number of rule permutations that randomly combine and modify different numbers of rule features and different values or ranges of values for each of these features. The combination of the number of rule features used in the rules and randomization of rule feature values together can create large numbers of candidate rules, the search space is much larger than the search space of a decision tree. The rule generation system is also able to specify multiple combinations of the categorical outputs as part of the rule, which is not trivial to do in more traditional modeling.

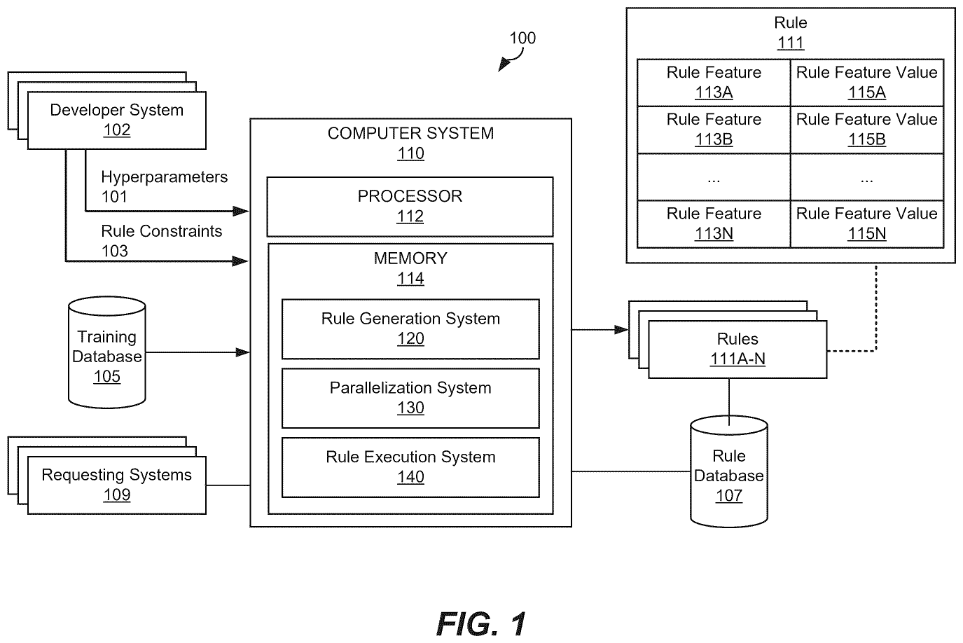

FIG. 1 illustrates an example of a system environment 100 of automatically generating rules based on an evolutionary algorithm, which may address these and other issues with conventional ways to generate rules. The system environment 100 may include a developer system 102, a training database 105, a training database 107, one or more requesting systems 109, a computer system 110, and/or other components. At least some of the components of the system environment 100 may be connected to one another via a communication network, which may include the Internet, an intranet, a Personal Area Network, a LAN (Local Area Network), a WAN (Wide Area Network), a SAN (Storage Area Network), a MAN (Metropolitan Area Network), a wireless network, a cellular communications network, a Public Switched Telephone Network, and/or other network through which system environment 100 components may communicate.

A developer system 102 is a computer or application that provides hyperparameters 101 and rule constraints 103 for training the rule generation system 120 to automatically generate rules 111. A user such as a developer may operate the developer system 102 to configure the hyperparameters 101 and rule constraints 103.

A hyperparameter 101 is a configurable parameter that controls various aspects of evolutionary learning. For example, a hyperparameter 101 may include a number of generations (which can also be referred to as “evolutions”), a population size, a mutation rate, and/or other configurable parameter. Each hyperparameter 101 may be predefined according to particular needs and/or may be optimized for specific training data.

The number of generations hyperparameter specifies the number of evolutionary iterations to perform. Each iteration includes a parent population of rules that are crossed, mutated, evaluated and selected to produce a child population of rules that become the parent population of any next iteration. The population size hyperparameter specifies the number of candidate rules considered in each generation. Larger population sizes may enable a larger possible set of candidate rules to be considered in each generation but requires more evolutionary complexity and computational resources.

The mutation rate hyperparameter specifies the probability of introducing random changes to candidate rules during an iteration. Higher mutation rates cause more variation in the rules and therefore increases the search space. Similar to larger population sizes, higher mutation rates may lead to increased computational burden due to greater probability of generating rules that will not be selected.

A rule constraint 103 is a constraint on how a rule may be mutated or otherwise modified. Rule constraints may therefore impose a limit on evolutionary outcomes to control over-randomization. Rule constraints 103 define the search space for identifying best performing (most fit) rules. Examples of rule constraints 103 may include a number of features to use (different rules in a generation can have different numbers of features to find an optimal number of features), feature ranges, feature compatibility (which features can be used with other features in a given rule), and/or other constraints.

A rule 111 is machine-executable logic that enables automatic generation of an outcome when applied to input data. A rule 111 may encode one or more rule features 113 (illustrated as rule features 113A-N) and their respective rule feature values 115 (or value ranges; illustrated as rule feature values 115A-N). A rule feature 113 is a characteristic of input data that can be used to classify the input data, such as determining an outcome of that input data. Each rule feature 113 has a corresponding rule feature value 115, which may be a single value or range of values.

The nature of the rule feature 113, logic and outcome will vary depending on the context in which the rule 111 is generated and executed. For example, in the context of network security, a rule feature 113 may be a number of failed logon attempts or a pattern of network access. The rule feature value 115 in this example may be the number of observed logon attempts or the pattern of network access (such as hops between network devices). A rule 111 may encode thresholds for one or more of these features. For example, a first rule 111 may encode that failed logon attempts greater than five indicate a potential security intrusion event. A second rule 111 may encode that a pattern of network access that indicates access times after 2:00 AM and/or from one or more blacklisted IP addresses indicate a potential security intrusion event. Other rules 111 may combine both of these features (and/or other combinations of features and their respective values).

In the context of transaction fraud risk, a feature 113 may specify a number of days since an email address was last seen/used, a transaction amount, and/or other aspect of a transaction. The corresponding rule feature value 115 in this example will be a value of the number of days, a value for the transaction amount, or other data from the transaction.

In some examples, rules 111 in a given population of rules may have the same number and type of features 113. In these examples, a first rule 111 may encode a first rule feature 113 that a number of days since an email address was last seen of 30 days indicates a potential fraudulent transaction and also a second rule feature 113 that indicates a transaction amount greater than 500 dollars indicates a potential fraudulent transaction. Other rules 111 may encode different rule feature values 115 for these rule features 113.

In some examples, rules 111 in a given population of rules may have different numbers or types of rule features 113. In these examples, a first rule 111 may encode that a number of days since an email address was last seen of 30 days indicates a potential fraudulent transaction. A second rule 111 may encode that a transaction amount greater than 500 dollars indicates a potential fraudulent transaction.

The training database 105 stores training data used by the computer system 110 to evaluate automatically generated rules for selecting top-performing rules in an evolutionary process. To that end, the training data may be labelled with known outcomes that the automatically generated rules will attempt to recreate so that the rules can be executed to accurately predict outcomes based on new input data. The system may identify features of the training data that are used to generate rules that are randomly initialized, crossed over with other rules, randomly mutated (changed), evaluated, and selected.

A requesting system 109 is a computer or application that requests an outcome to be generated based on input data. The computer system 110 may evaluate the input data against one or more rules 111 to generate an outcome. For example, the computer system 110 may execute logic in the one or more rules 111 using the input data to determine the outcome. In the network security example, the input data may include data from logfiles and the outcome may be a prediction indicating a probability that a network intrusion event has (or has not) occurred. In the financial transaction example, the input data may include transaction data and the outcome may be a prediction indicating a probability that a transaction is fraudulent.

The computer system 110 may include one or more computing devices that automatically generate rules 111 based on one or more hyperparameters 101, one or more rule constraints 103, data from the training database 105, and an evolutionary algorithm. The one or more computing devices of the computer system 110 may each include a processor 112, a memory 114, a rule generation system 120, and/or other components.

The processor 112 may be a semiconductor-based microprocessor, a central processing unit (CPU), an application specific integrated circuit (ASIC), a field-programmable gate array (FPGA), and/or other suitable hardware device. Although the computer system 110 has been depicted as including a single processor 112, it should be understood that the computer system 110 may include multiple processors, multiple cores, or the like. The memory 114 may be an electronic, magnetic, optical, or other physical storage device that includes or stores executable instructions. The memory 114 may be, for example, Random Access memory (RAM), an Electrically Erasable Programmable Read-Only Memory (EEPROM), a storage device, an optical disc, and the like. The memory 114 may be a non-transitory machine-readable storage medium, where the term “non-transitory” does not encompass transitory propagating signals.

The computer system 110 may include a rule generation system 120, a parallelization system 130, and a rule execution system 140, which may each be implemented as instructions that program the processor 112. Alternatively, or additionally, the rule generation system 120, the parallelization system 130, and the rule execution system 140 may be implemented in hardware.

The rule generation system 120 may use data from the training database 105 to implement an evolutionary algorithm that automatically generates rules 111 based on the hyperparameters 101, rule constraints 103, and the training data from the training database 105. In some examples, at least some of the evolutionary algorithm may be parallelized through the parallelization system 130, which may include hardware and/or software load balancers that manage splitting some or all of the evolutionary process, such as fitness evaluation, into parallelized tasks. Once the rules 111 are generated, the rule execution system 140 may access input data from a requesting system 109, evaluate the input data against one or more rules 111, and generate an outcome based on the evaluation.

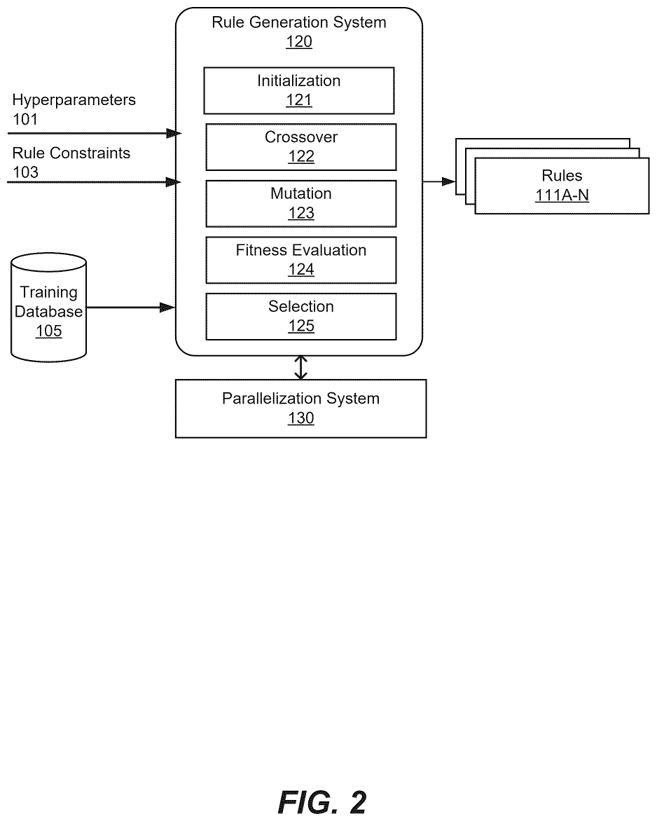

FIG. 2 illustrates an example of evolutionary processes of a rule generation system 120 for generating rules. The rule generation system 120 may include evolutionary processes such as initialization 121, crossover 122, mutation 123, fitness evaluation 124, and selection 125. The evolutionary processes iteratively initialize, crosses, and mutates rules 111 over a specified number of generations to introduce new rule variants, which are evaluated against labelled data with known outcomes. Top performing (“most fit”) rule variants are selected for inclusion in the next generation, or if the last generation, selected as the automatically generated rules.

### Rule Population Initialization

Initialization 121 is a process that generates an initial set of rules based on one or more hyperparameters 101 and one or more rule constraints 103. For example, the initial set of rules may be limited to the population size hyperparameter. The one or more constraints 103 define the search space in terms of how rules can evolve through different generations.

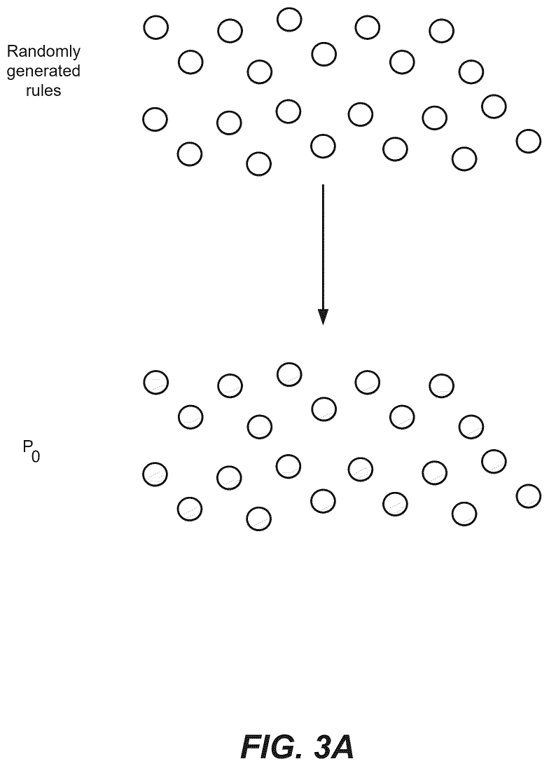

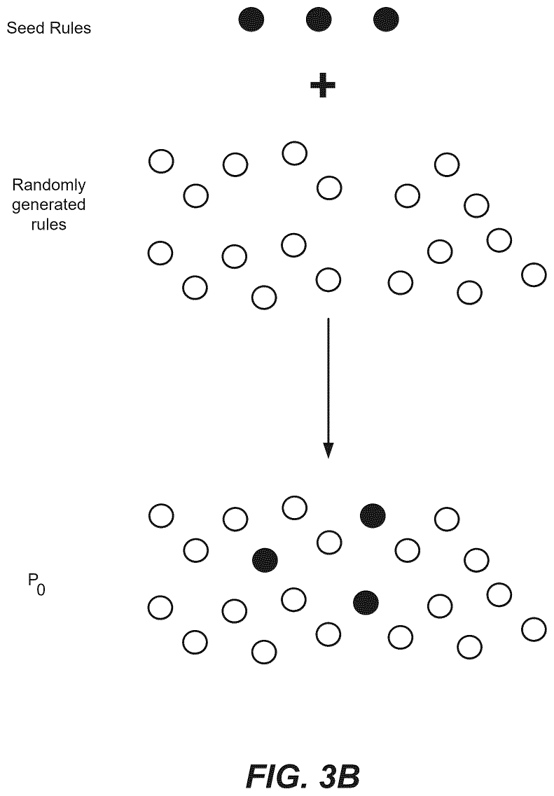

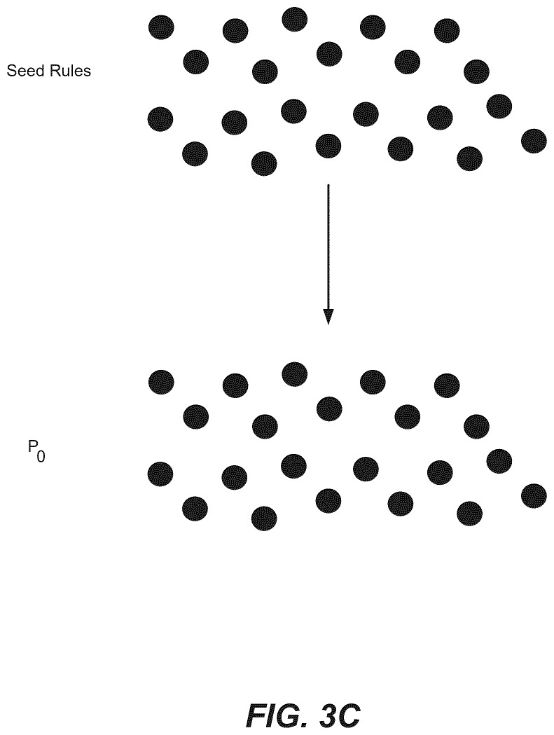

During initialization 121, the rule generation system 120 may generate an initial population of rules for the first generation of rules based on the hyperparameters 101 and the rule constraints 103. In some examples, the initial population (P₀) is completely randomly generated, as illustrated in FIG. 3A. In other examples, the initial population (P₀) may be seeded with seed rules, which may be added to a randomly generated initial population of rules or may make up the entire initial population, as illustrated in FIG. 3B. In still other examples, the initial population (P₀) is entirely seeded with seed rules, as illustrated in FIG. 3C. In either case, the initial population of rules may be limited to a population size hyperparameter. For example, if the population size hyperparameter is 50, then the rule generation system 120 will generate an initial population of 50 rules.

To randomly generate a rule for the initial population, the rule generation system 120 may, for each rule feature 113, randomly select a value within the rule constraints 103. To illustrate, a rule 111 having two rule features: (1) number of days since an email was last seen (“email last seen”), and (2) transaction amount will be described. Other numbers and types of rule features may be used. For the first rule feature, a first rule constraint 103 may be imposed to limit the feature value to be between 0 and 100. For the second rule feature a second rule constraint 103 may be imposed to set the feature value to be between 100 dollars and 5,000 dollars. In this example, the rule generation system 120 may generate a rule by randomly selecting a number between 0 and 100 for the email last seen feature and a dollar amount between 100 and 5,000. The rule generation system 120 may repeat this process a number of times to randomly generate an initial population of rules that has a predefined initial population size. The predefined initial population size may be equal to or less than the population size hyperparameter.

Each of the rules may therefore have randomly selected rule feature values for fitness evaluation and selection. In some examples, at least some of the initial population of 50 rules will have different numbers or types of rule features. In these examples, the rule generation system 120 may randomly omit a particular rule feature from an initial rule. To illustrate, some rules may have both email last seen and transaction amount rule features, while other rules may have one or the other but not both rule feature. If seed rules have been provided by a user such as a developer, the rule generation system 120 may add the seed rules to the initial population and randomly generate initial rules up to the population size hyperparameter (and add zero randomly generated initial rules if the number of seed rules are equal to or exceed the population size hyperparameter).

### Rule Crossover

Crossover 122 is a process that generates new (child) rules based on a combination of two or more (parent) rules. In the initial generation, the rules generated during initialization 121 are crossed with one another to generate child rules that are evaluated. In subsequent generations, the child rules that were selected in the prior generation are crossed with one another. During crossover 122, the rule generation system 120 randomly select two or more rules from the initial population or from an immediately prior generation for crossing with one another to generate a child rule. The rule generation system 120 may repeat the crossover process to generate a number of child rules.

The rule generation system 120 may generate different types of crossovers. For example, the crossovers may include an equal combination, a weighted combination, a dominant combination, an, and/or other types of combinations. The particular type of crossover used may be a hyperparameter input and/or may be randomly selected during crossover 122. An equal combination occurs when the rule generation system 120 takes an average of feature values from two or more parent rules. For example, if a first rule with an email last seen value of 50 is crossed with a second rule with an email last seen value of 20, the rule generation system 120 may generate a child rule from the first and second rule with an email last seen value of 35.

A weighted combination occurs when the rule generation system 120 takes a weighted average of two or more parent rules. Continuing the foregoing example, the rule generation system 120 may weight the first rule's email last seen value of 50 one and a half times (1.5X) more so than the second rule's email last seen value of 20 to determine a weighted average of 47.5 (or rounded up to 48) for the child rule's email last seen feature.

A dominant combination occurs when the rule generation system 120 takes one parent's rule feature and not another parent's rule feature. Still continuing the foregoing example, the rule generation system 120 may use only first rule's email last seen value of 50 and disregard the second rule's email last seen value of 20 to determine a last seen value of 50 for the child rule's email last seen feature.

An added feature occurs when a first parent rule is crossed with a second parent rule, only one of the parent rules has a rule feature, and the rule feature is added to the resulting child rule. For example, if a first parent rule has a transaction amount rule feature and a second parent rule does not, the rule generation system 120 may add the transaction amount rule feature to the resulting child rule, using the first parent's transaction amount rule feature value.

A removed feature occurs when a first parent rule is crossed with a second parent rule, only one of the parent rules has a rule feature, but the rule feature is removed so that it is not included in the resulting child rule. For example, if a first parent rule has a transaction amount rule feature and a second parent rule does not, the rule generation system 120 may not add the transaction amount rule feature to the resulting child rule.

### Rule Mutation

Mutation 123 is a process that randomly changes one or more feature values of a given rule in the current generation. Mutations 126 may maintain rule diversity by introducing random changes to individual rule features, which may result in new combinations of rules that may perform better than existing rules. Mutations 126 may also address local optima in rules, which may result in a global optima by expanding the possible search space of feature rule values.

The probability of a mutation being applied to a given rule may be controlled by the mutation hyperparameter. During mutation 123, the rule generation system 120 may randomly select a rule to mutate, and then apply a mutation. The rule generation system 120 may apply different types of mutations, such as binary mutations, control mutations, random value mutations, and order mutations.

Binary mutation is a mutation in which (feature values may have a flag that when checked to 1 is used, 0 not used). Binary mutation may flip this value (e.g., if a rule was 0 it might be flipped to 1). Control mutation is a mutation in which an “and”, “or,” and “and/or” control logic may be mutated. For example, a rule may include two rule features considered together. To illustrate, a rule may have a rule feature “email last seen” value of 30 and transaction value of “500” such that any email last seen of greater than 30 days and transaction value greater than 500 will be flagged as potentially fraudulent. A control mutation may change this to be an “or” operator such that either of these rule features can be satisfied instead of both. Random value mutation is a mutation in which a feature values is modified. In some examples, random value mutation may be based on a random value drawn from a Gaussian distribution of all feature values of the current generation. Order mutation is a mutation in which an order of rule features is changed. For example, if a sequence of rule features is to be executed in an order, then the order of execution may be modified.

### Rule Fitness Evaluation

Fitness evaluation 124 is a process that evaluates fitness, or performance, of a candidate rule such as after initialization 121, crossover 122, and/or mutation 123. During fitness evaluation 124, the rule generation system 120 may apply the candidate rule to multiple labelled data from the training database 105 to generate predicted outcomes, one for each labelled data. The rule generation system 120 may apply fitness evaluation metrics based on the predicted outcomes. For example, the rule generation system 120 may compare predicted outcomes predicted by a given rule using the labelled data against known outcomes of the labelled data and use the comparisons to generate fitness evaluation metrics for each rule. The fitness evaluation metrics may include precision, recall, an F1 score, and/or other performance metrics.

Precision is the ratio of correctly predicted positive outcomes to the total predicted positive outcomes (true positives and false positives). For example, precision of a given rule may be determined based on a ratio of the number of times that the given rule correctly predicted a positive outcome (such as fraud) and the sum of the number of correctly predicted positive outcomes and the number of incorrectly predicted positive outcomes. Recall is the ratio of correctly predicted positive observations to all the observations in the actual class. F1 Score is the harmonic mean of precision and recall. It is a measure of a given rule's accuracy based on both precision and recall.

Other types of fitness evaluation metrics may be used as well, or instead of the foregoing examples. Non-limiting examples, include, without limitation, accuracy, balanced accuracy, specificity, Receiver Operating Characteristic−Area Under Curve (ROC-AUC), Precision Recall AUC, and/or other ways to measure performance of predicted outcomes of a rule against known outcomes.

### Rule Selection

Selection 125 is a process that selects rules in a given generation based on one or more of the fitness evaluation metrics generated during fitness evaluation 124. During selection 125, the rule generation system 120 may rank rules in a given generation with respect to one another, and select top N performing rules, where N may be equal to the population size hyperparameter. If more generations are to be performed, the top N performing rules will be used for the next generation and the rule generation system 120 repeats the evolutionary process. If the current generation is the final generation, the rule generation system 120 will select the top N performing rules as the output set of rules 111 for execution by the rule execution system 140.

### Evolutionary Process Parallelization

The parallelization system 130 may parallelize one or more evolutionary processes, such as initialization 121, crossover 122, mutation 123, fitness evaluation 124, and selection 125. In particular, the rule generation system 120 may parallelize fitness evaluation 124 because of the computational burden imposed by executing candidate rules in a given generation against the labelled data and then generating evaluation metrics based on the candidate rule executions. Parallelization is the process of breaking down a task into multiple sub-tasks that are executed in parallel across multiple computer resources such as processors. Doing so may efficiently handle a large task. The rule generation system 120 may, using the parallelization system 130, parallelize some or all of the evolutionary processes.

To illustrate, parallelization of fitness evaluation 124 will be described because this process has been determined to be among the top consumers computer resources (if not the top consumer) from among the evolutionary processes. The rule generation system 120 may cluster the number of rules to be evaluated into groups. Each group of rules may be evaluated via respective computer resources. In this way, the rule generation system 120 may split up the task of evaluating rules during fitness evaluation 124 and/or other evolutionary process for parallel execution. The rule generation system 120 may aggregate the results of fitness evaluation 124 for each of the parallel groups so that they may all be considered for selection.

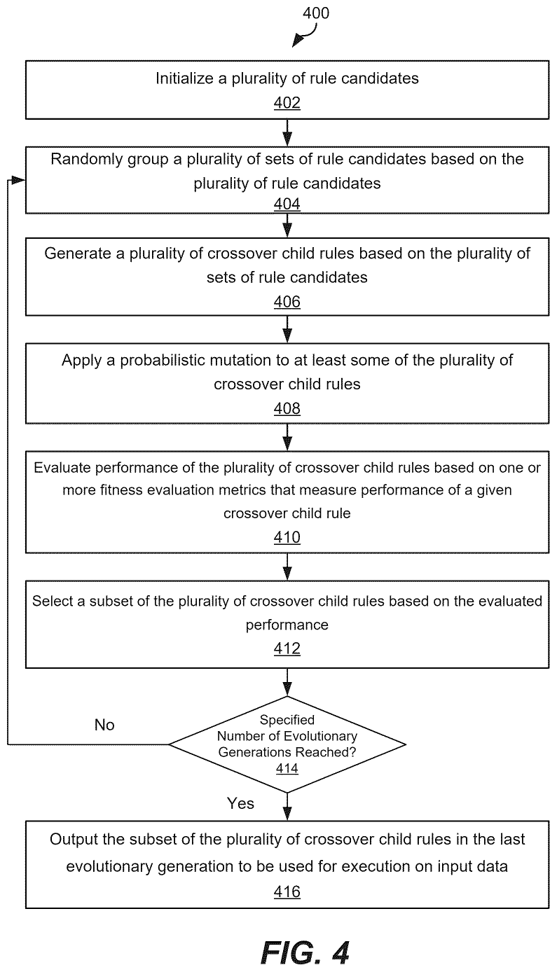

FIG. 4 illustrates an example of a method 400 for automatically generating rules 111 based on an evolutionary process.

At 402, the method 400 may include (i) initializing a plurality of rule candidates. Each rule candidate being bound by one or more respective constraints, each rule candidate comprising machine-e4ecutable logic to perform an automated function such as classifying input data. Initializing may be based on randomization only (as illustrated in FIG. 3A), seeding with randomization (as illustrated in FIG. 3B), or seeding only (as illustrated in FIG. 3C).

At 404, the method 400 may include (ii) randomly grouping a plurality of sets of rule candidates based on the plurality of rule candidates, each set of rule candidates having at least two rule candidates selected from the plurality of rule candidates.

At 406, the method 400 may include (iii) generating a plurality of crossover child rules based on the plurality of sets of rule candidates, each crossover child rule being generated from a corresponding set of rule candidates.

At 408, the method 400 may include (iv) applying a probabilistic mutation to at least some of the plurality of crossover child rules.

At 410, the method 400 may include (v) evaluating performance of the plurality of crossover child rules based on one or more fitness evaluation metrics that measure performance of a given crossover child rule.

At 412, the method 400 may include (vi) selecting, a subset of the plurality of crossover child rules based on the evaluated performance.

At 414, the method 400 may include determining whether a specified number of evolutionary generations is reached. The specified number may be input as a number of generations hyperparameter input.

If the specified number is not reached, the method x00 may return to x04, using the selected subset as the parents for the next generation. If the specified number has been reached, the method 400 may, at 416, output the subset of the plurality of crossover child rules in the last evolutionary generation to be used for execution on input data.

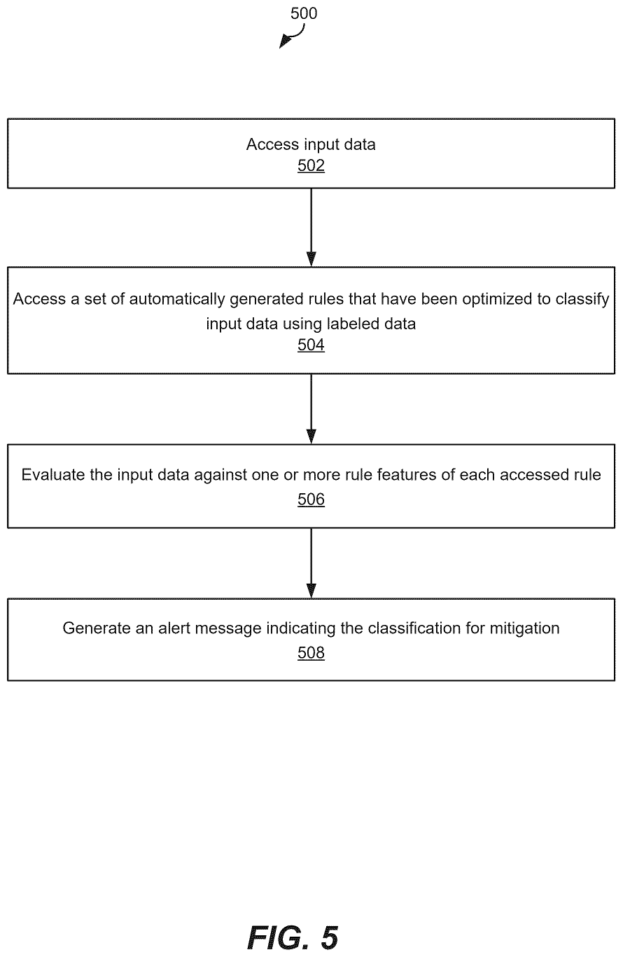

FIG. 5 illustrates an example of a method 500 for executing automatically generated rules to classify input data. At 502, the method 500 may include accessing input data. The input data may include network log data in a network security context or transaction data in a payment transaction context. Other types of input data may be used depending on the context.

At 504, the method 500 may include accessing a set of automatically generated rules that have been optimized to classify input data using labeled data.

At 506, the method 500 may include evaluating the input data against one or more rule features of each accessed rule. Evaluating may include executing the logic of the accessed rules to classify the input data. For example, in the network security context, the method 500 may classify the network log data as a network intrusion event. Put another way, the method 500 may determine that the network log data indicates a network intrusion event occurred based on the evaluation. In the payment transaction context, the method 500 may classify the transaction data as fraudulent. Put another way, the method 500 may determine that the transaction data indicates a fraudulent activity occurred based on the evaluation. At 508, the method 500 may include generating an alert message indicating the classification. Such message may be used to mitigate adverse classifications, such as by containing the network intrusion or placing a hold on an account associated with the payment transaction.

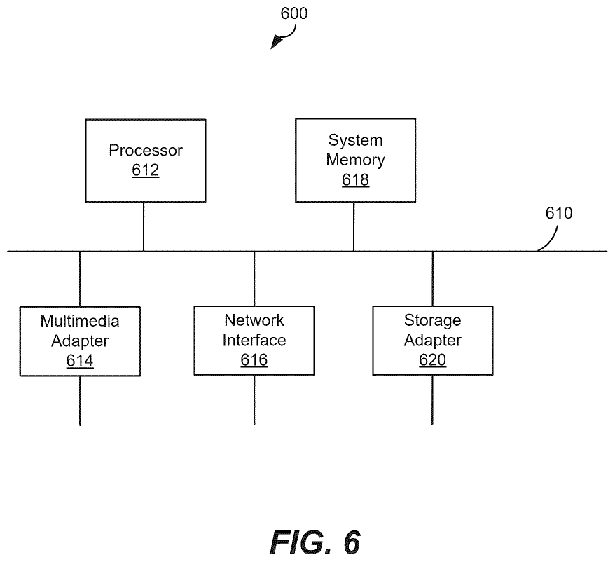

FIG. 6 illustrates an example of a computer system 600 that may be implemented by devices illustrated in FIG. 1. The computer system 600 may be part of or include the system environment 100 to perform the functions and features described herein. For example, various ones of the devices of system environment 100 may be implemented based on some or all of the computer system 600. The computer system 600 may include, among other things, an interconnect 610, a processor 612, a multimedia adapter 614, a network interface 616, a system memory 618, and a storage adapter 620.

The interconnect 610 may interconnect various subsystems, elements, and/or components of the computer system 600. As shown, the interconnect 610 may be an abstraction that may represent any one or more separate physical buses, point-to-point connections, or both, connected by appropriate bridges, adapters, or controllers. In some examples, the interconnect 610 may include a system bus, a peripheral component interconnect (PCI) bus or PCI-Express bus, a HyperTransport interconnect, an industry standard architecture (ISA)) bus, a small computer system interface (SCPI) bus, a universal serial bus (USB), IIC (I2C) bus, or an Institute of Electrical and Electronics Engineers (IEEE) standard 1384 bus, or “firewire,” or other similar interconnection element.

In some examples, the interconnect 610 may allow data communication between the processor 612 and system memory 618, which may include read-only memory (ROM) or flash memory (neither shown), and random-access memory (RAM) (not shown). It should be appreciated that the RAM may be the main memory into which an operating system and various application programs may be loaded. The ROM or flash memory may contain, among other code, the Basic Input-Output system (BIOS) which controls basic hardware operation such as the interaction with one or more peripheral components.

The processor 612 may control operations of the computer system 600. In some examples, the processor 612 may do so by executing instructions such as software or firmware stored in system memory 618 or other data via the storage adapter 620. In some examples, the processor 612 may be, or may include, one or more programmable general-purpose or special-purpose microprocessors, digital signal processors (DSPs), programmable controllers, application specific integrated circuits (ASICs), programmable logic device (PLDs), trust platform modules (TPMs), field-programmable gate arrays (FPGAs), other processing circuits, or a combination of these and other devices.

The multimedia adapter 614 may connect to various multimedia elements or peripherals. These may include devices associated with visual (e.g., video card or display), audio (e.g., sound card or speakers), and/or various input/output interfaces (e.g., mouse, keyboard, touchscreen).

The network interface 616 may provide the computer system 600 with an ability to communicate with a variety of remote devices over a network. The network interface 616 may include, for example, an Ethernet adapter, a Fibre Channel adapter, and/or other wired-or wireless-enabled adapter. The network interface 616 may provide a direct or indirect connection from one network element to another, and facilitate communication to and between various network elements. The storage adapter 620 may connect to a standard computer readable medium for storage and/or retrieval of information, such as a fixed disk drive (internal or external).

Other devices, components, elements, or subsystems (not illustrated) may be connected in a similar manner to the interconnect 610 or via a network. The devices and subsystems can be interconnected in different ways from that shown in FIG. 6. Instructions to implement various examples and implementations described herein may be stored in computer-readable storage media such as one or more of system memory 618 or other storage. Instructions to implement the present disclosure may also be received via one or more interfaces and stored in memory. The operating system provided on computer system 600 may be MS-DOS®, MS-WINDOWS®, OS/2®, OS X®, IOS®, ANDROID®, UNIX®, Linux®, or another operating system.

“Artificial intelligence” refers to is a branch of computer science focused on training computer models via machine learning techniques to perform tasks, such as email address classification. Throughout the disclosure, the terms “a” and “an” may be intended to denote at least one of a particular element. As used herein, the term “includes” means includes but not limited to, the term “including” means including but not limited to. The term “based on” means based at least in part on. In the Figures, the use of the letter “N” to denote plurality in reference symbols is not intended to refer to a particular number. For example, “101A-N” does not refer to a particular number of instances of 101A-N, but rather “two or more.”

The databases (such as 105, 107, which may store model features, parameters, hyperparameters, and/or other data related to training or executing the email classification model 142) may be, include, or interface to, for example, an Oracle™ relational database sold commercially by Oracle Corporation. Other databases, such as Informix™, DB2 or other data storage, including file-based, or query formats, platforms, or resources such as OLAP (On Line Analytical Processing), SQL (Structured Query Language), a SAN (storage area network), Microsoft Access™ or others may also be used, incorporated, or accessed. The database may comprise one or more such databases that reside in one or more physical devices and in one or more physical locations. The database may include cloud-based storage solutions. The database may store a plurality of types of data and/or files and associated data or file descriptions, administrative information, or any other data. The various databases may store predefined and/or customized data described herein.

The systems and processes are not limited to the specific embodiments described herein. In addition, components of each system and each process can be practiced independently and separate from other components and processes described herein. Each component and process may also be used in combination with other assembly packages and processes. The flow charts and descriptions thereof herein should not be understood to prescribe a fixed order of performing the method blocks described therein. Rather the method blocks may be performed in any order that is practicable including simultaneous performance of at least some method blocks. Furthermore, each of the methods may be performed by one or more of the system components illustrated in FIG. 1.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

While the disclosure has been described in terms of various specific embodiments, those skilled in the art will recognize that the disclosure can be practiced with modification within the spirit and scope of the claims.

As will be appreciated based on the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. Example computer-readable media may be, but are not limited to, a flash memory drive, digital versatile disc (DVD), compact disc (CD), fixed (hard) drive, diskette, optical disk, magnetic tape, semiconductor memory such as read-only memory (ROM), and/or any transmitting/receiving medium such as the Internet or other communication network or link. By way of example and not limitation, computer-readable media comprise computer-readable storage media and communication media. Computer-readable storage media are tangible and non-transitory and store information such as computer-readable instructions, data structures, program modules, and other data. Communication media, in contrast, typically embody computer-readable instructions, data structures, program modules, or other data in a transitory modulated signal such as a carrier wave or other transport mechanism and include any information delivery media. Combinations of any of the above are also included in the scope of computer-readable media. The article of manufacture containing the computer code may be made and/or used by executing the code directly from one medium, by copying the code from one medium to another medium, or by transmitting the code over a network.

This written description uses examples to disclose the embodiments, including the best mode, and to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system, comprising:
a processor programmed to:
(i) initialize a plurality of rule candidates, each rule candidate being bound by one or more respective constraints, each rule candidate comprising machine-executable logic to perform an automated function;
(ii) randomly group a plurality of sets of rule candidates based on the plurality of rule candidates, each set of rule candidates having at least two rule candidates selected from the plurality of rule candidates;
(iii) generate a plurality of crossover child rules based on the plurality of sets of rule candidates, each crossover child rule being generated from a corresponding set of rule candidates;
(iv) apply a probabilistic mutation to at least some of the plurality of crossover child rules;
(v) evaluate performance of the plurality of crossover child rules based on one or more fitness evaluation metrics that measure performance of a given crossover child rule;
(vi) select a subset of the plurality of crossover child rules based on the evaluated performance, and repeat (ii)-(vi) until a specified number of evolutionary generations is reached; and
(vii) after the specified number of evolutionary generations is reached, output the subset of the plurality of crossover child rules in a last evolutionary generation to be used for execution on input data.

2. The system of claim 1, wherein to select the subset, the processor is further programmed to:
rank the performance of each crossover child rule against other crossover child rules generated in the same evolutionary generation.

3. The system of claim 1, wherein the crossover child rule is selected and included in a next evolutionary generation.

4. The system of claim 1, wherein the crossover child rule is not selected and omitted a next evolutionary generation.

5. The system of claim 1, wherein the processor is further programmed to:
seed an existing rule to include with the plurality of rule candidates, wherein the existing rule is fine-tuned in the evolutionary generations.

6. The system of claim 1, wherein to evaluate the performance, the processor is programmed to:
apply the rule to training data to generate a predicted outcome based on the training data, the training data having a known outcome;
compare the predicted outcome to the known outcome; and
determine a performance of the rule based on the comparison.

7. The system of claim 1, wherein to apply the probabilistic mutation, the processor is programmed to:
select a portion of a rule to modify; and
modify the selected portion.

8. The system of claim 7, wherein to modify the selected portion, the processor is programmed to:
change a logical “or” expression to a logical “and” expression or vice versa.

9. The system of claim 7, wherein to modify the selected portion, the processor is programmed to:
delete a condition from among a plurality of conditions of the rule.

10. The system of claim 7, wherein to modify the selected portion, the processor is programmed to:
alter a threshold value associated with the rule.

11. The system of claim 1, wherein the one or more respective constraints comprises a number of features to use for each rule candidate, a feature range for each feature, and/or a feature compatibility.

12. The system of claim 1, wherein the processor is programmed to execute subject to one or more hyperparameters comprising a number of evolutionary generations to use, a population size, and/or a mutation rate.

13. The system of claim 1, wherein the one or more fitness evaluation metrics comprise a precision, a recall, and/or an F1-Score.

14. A method, comprising:
(i) initializing, by a processor, a plurality of rule candidates, each rule candidate being bound by one or more respective constraints, each rule candidate comprising machine-executable logic to perform an automated function;
(ii) randomly grouping, by the processor, a plurality of sets of rule candidates based on the plurality of rule candidates, each set of rule candidates having at least two rule candidates selected from the plurality of rule candidates;
(iii) generating, by the processor, a plurality of crossover child rules based on the plurality of sets of rule candidates, each crossover child rule being generated from a corresponding set of rule candidates;
(iv) applying, by the processor, a probabilistic mutation to at least some of the plurality of crossover child rules;
(v) evaluating, by the processor, performance of the plurality of crossover child rules based on one or more fitness evaluation metrics that measure performance of a given crossover child rule;
(vi) selecting, by the processor, a subset of the plurality of crossover child rules based on the evaluated performance, and repeat (ii)-(vi) until a specified number of evolutionary generations is reached; and
(vii) after the specified number of evolutionary generations is reached, outputting, by the processor, the subset of the plurality of crossover child rules in a last evolutionary generation to be used for execution on input data.

15. The method of claim 14, wherein to select the subset, the processor is further programmed to:
ranking the performance of each crossover child rule against other crossover child rules generated in the same evolutionary generation.

16. The method of claim 14, further comprising:
seeding an existing rule to include with the plurality of rule candidates, wherein the existing rule is fine-tuned in the evolutionary generations.

17. The method of claim 14, wherein to evaluate the performance, the processor is programmed to:
applying the rule to training data to generate a predicted outcome based on the training data, the training data having a known outcome;
comparing the predicted outcome to the known outcome; and
determining a performance of the rule based on the comparison.

18. The method of claim 14, wherein applying the probabilistic mutation comprises:
randomly determine that the probabilistic mutation should occur based on a mutation rate hyperparameter that specifies how often a mutation is to occur; and modifying at least one rule feature value.

19. A non-transitory computer readable medium storing instructions that, when executed by a processor, programs the processor to:
(i) initialize a plurality of rule candidates, each rule candidate being bound by one or more respective constraints, each rule candidate comprising machine-executable logic to perform an automated function;
(ii) randomly group a plurality of sets of rule candidates based on the plurality of rule candidates, each set of rule candidates having at least two rule candidates selected from the plurality of rule candidates;
(iii) generate a plurality of crossover child rules based on the plurality of sets of rule candidates, each crossover child rule being generated from a corresponding set of rule candidates;
(iv) apply a probabilistic mutation to at least some of the plurality of crossover child rules;
(v) evaluate performance of the plurality of crossover child rules based on one or more fitness evaluation metrics that measure performance of a given crossover child rule;
(vi) select a subset of the plurality of crossover child rules based on the evaluated performance, and repeat (ii)-(vi) until a specified number of evolutionary generations is reached; and
(vii) after the specified number of evolutionary generations is reached, output the subset of the plurality of crossover child rules in a last evolutionary generation to be used for execution on input data.

20. The non-transitory computer readable medium of claim 19, wherein to select the subset, the instructions further program the processor to:
rank the performance of each crossover child rule against other crossover child rules generated in the same evolutionary generation.
